(19) United States
(12) Patent Application Publication
(10) Pub. No.: US 2025/0112433 A1
(43) Pub. Date: Apr. 3, 2025

(54) LASER OSCILLATOR

(71) Applicant: Via Mechanics, Ltd., Kanagawa-ken (JP)

(72) Inventors: Kazuya MATSUMOTO, Kanagawa-ken (JP); Nobuyoshi OHTANI, Kanagawa-ken (JP)

(21) Appl. No.: 18/894,261

(22) Filed: Sep. 24, 2024

(30) Foreign Application Priority Data
Sep. 28, 2023 (JP) 2023-168681

(51) Int. Cl. H01S 3/038; H01S 3/08

(52) U.S. Cl. CPC H01S 3/0385; H01S 3/08059

(57) ABSTRACT

A laser oscillator includes an outer electrode, an inner electrode forming a discharge chamber between the inner electrode and the outer electrode, a first resonator mirror provided on a first end side of the outer electrode and the inner electrode, a second resonator mirror provided on a second end side of the outer electrode and the inner electrode and configured to reflect the laser light between the second resonator mirror and the first resonator mirror, and a support member configured to support the inner electrode. The support member has an opening portion through which the laser light passes at a position corresponding to the discharge chamber, and at least a part of the opening portion has an opening width smaller than a beam diameter of the laser light emitted from the discharge chamber and serves as a space filter portion.

### BACKGROUND OF THE INVENTION

### Field of the Invention

The present invention relates to a laser oscillator.

### Description of the Related Art

In recent years, a cylindrical slab gas laser device configured to emit a uniform beam appropriate for processing so that an intensity distribution of laser light is close to a Gaussian distribution has been devised as a laser oscillator (see JP 2001-332785 A).

However, even in such a laser oscillator, noise may occur in a pulse waveform of an output laser. There is a problem that the noise affects quality of laser light. For example, when a printed circuit board is drilled using the laser light in which such noise has been generated, processing quality of a hole may end up deteriorating.

### SUMMARY OF THE INVENTION

Accordingly, the present invention provides a laser oscillator capable of emitting high-quality laser light.

According to one aspect of the present invention, a laser oscillator includes a cylindrical outer electrode, an inner electrode disposed concentrically with the outer electrode and forming a discharge chamber filled with a laser medium between the inner electrode and the outer electrode, a first resonator mirror provided on a first end side of the outer electrode and the inner electrode and configured to reflect laser light emitted from the discharge chamber, a second resonator mirror provided on a second end side of the outer electrode and the inner electrode and configured to reflect the laser light between the second resonator mirror and the first resonator mirror, and a support member configured to support the inner electrode. The support member has an opening portion through which the laser light passes at a position corresponding to the discharge chamber, and at least a part of the opening portion has an opening width smaller than a beam diameter of the laser light emitted from the discharge chamber and serves as a space filter portion.

Further features of the present invention will become apparent from the following description of exemplary embodiments with reference to the attached drawings.

### BRIEF DESCRIPTION OF THE DRAWINGS

FIG. 1 is an exploded view illustrating a structure of a laser oscillator according to an embodiment of the present invention.

FIG. 2 is a view illustrating right end sides of an outer electrode and an inner electrode as viewed from a bracket side.

FIG. 3 is a cross-sectional view illustrating the laser oscillator taken in a longitudinal direction.

FIG. 4 is a schematic view illustrating a bracket.

FIG. 5 is a schematic view illustrating a reflection path of laser light.

FIG. 6A is a view illustrating a relationship between reflectance of a first resonator mirror and a wavelength of laser light.

FIG. 6B is a view illustrating a relationship between an oscillation line and a wavelength of laser light emitted from the discharge chamber.

FIG. 7A is a view illustrating a pulse waveform of laser light emitted from a laser oscillator in a comparative example.

FIG. 7B is a view illustrating a pulse waveform of laser light emitted from the laser oscillator according to the embodiment.

### DESCRIPTION OF THE EMBODIMENTS

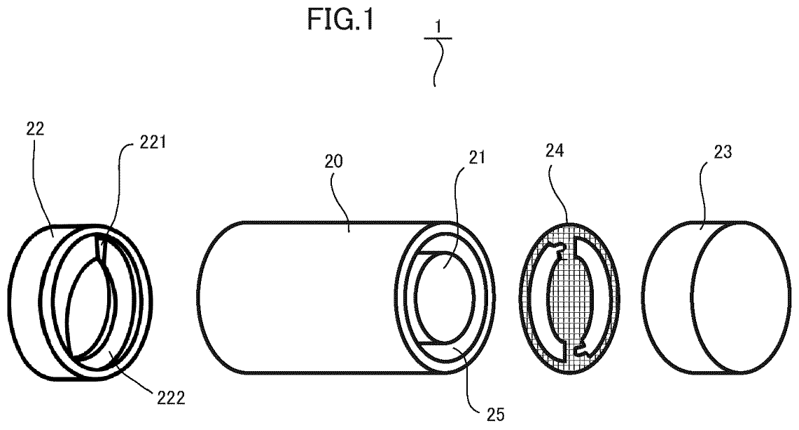

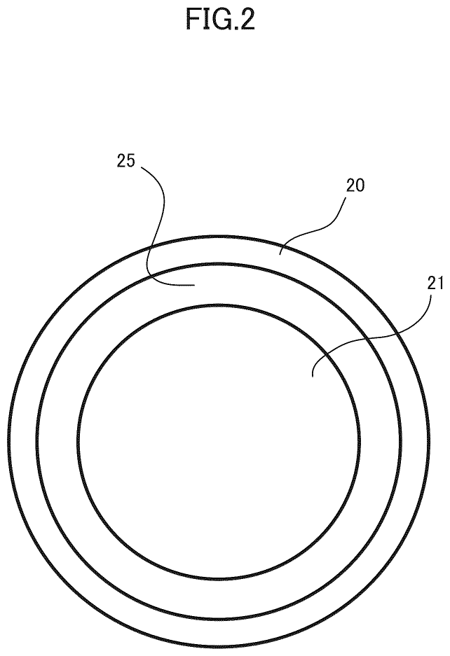

Hereinafter, a laser oscillator 1 according to an embodiment of the present invention will be described with reference to the drawings. As illustrated in FIG. 1, the laser oscillator 1 according to the embodiment is a cylindrical slab type CO2 laser oscillator and includes an outer electrode 20, an inner electrode 21, resonator mirrors 22 and 23, and a bracket 24. More specifically, in the laser oscillator 1, the cylindrical outer electrode 20 and inner electrode 21 that have different diameters are concentrically arranged. A discharge chamber 25 is formed between the outer electrode 20 and the inner electrode 21 (see also FIG. 2). The discharge chamber 25 is filled with a laser medium such as CO2. When high-frequency power is applied between the outer electrode 20 and the inner electrode 21, the laser medium is excited and laser light Lis emitted.

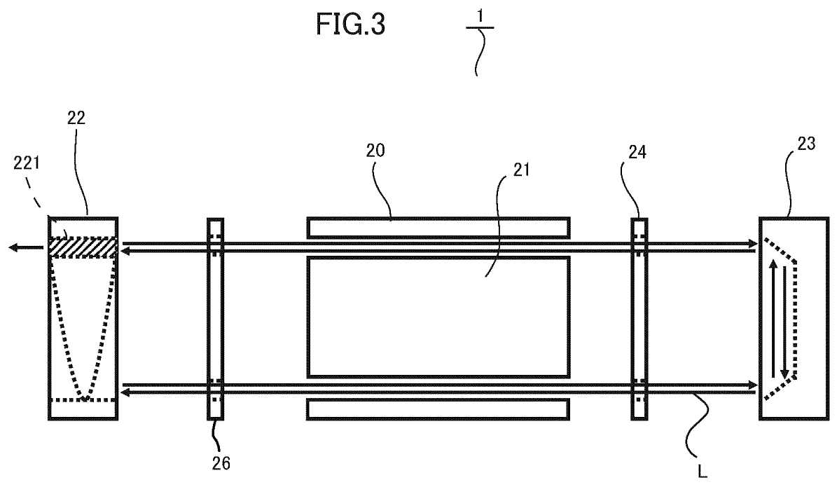

The first resonator mirror 22 is provided at an end of the laser oscillator 1 on an emission side of the laser light and is configured such that an inner surface 222 is formed in a spiral shape and the laser light is shifted and reflected. The second resonator mirror 23 is provided at an end opposite to the first resonator mirror 22 and is configured so as to reflect the laser light toward the first resonator mirror 22. Therefore, as illustrated in FIG. 3, the laser light L emitted from the discharge chamber 25 is folded back and reflected between the resonator mirrors 22 and 23, and finally emitted from an output window 221 provided in the first resonator mirror 22.

Also, as illustrated in FIGS. 1 and 3, in the longitudinal direction of the laser oscillator, the above-described bracket 24 is provided between the second resonator mirror 23 and a cylindrical slab (electrode) formed by the outer electrode 20 and the inner electrode 21. A spacer 26 is provided between the cylindrical slab and the first resonator mirror 22. Each of the bracket 24 and the spacer 26 is a member that fixes and supports the inner electrode 21. The inner electrode 21 is supported at both ends by the bracket 24 and the spacer 26. In addition, the inner electrode 21 is insulated from the outer electrode 20, the bracket 24, the resonator mirrors 22 and 23, and the spacer 26 by an insulator (not illustrated).

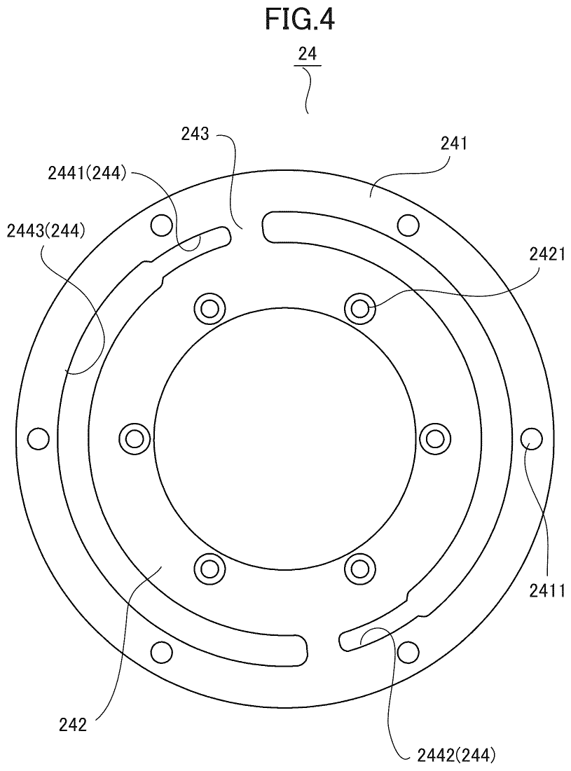

Next, a configuration of the bracket 24 will be described. As illustrated in FIG. 4, the bracket 24 includes an outer support circle 241 attached to the outer electrode 20, an inner support circle 242 to which the inner electrode 21 is attached, and a connection portion (column portion) 243 that connects the outer support circle 241 to the inner support circle 242. The outer support circle 241 is formed in a ring shape that has a predetermined width in accordance with the end surface shape of the outer electrode 20, and attachment holes 2411 for attaching the bracket 24 to the outer electrode 20 are formed at a plurality of locations in the circumferential direction.

Also, the inner support circle 242 is formed in a ring shape that has a diameter less than that of the outer support circle 241 in accordance with the end surface shape of the inner electrode 21. Attachment holes 2421 for attaching the inner electrode 21 to the bracket 24 are formed at a plurality of locations in the circumferential direction.

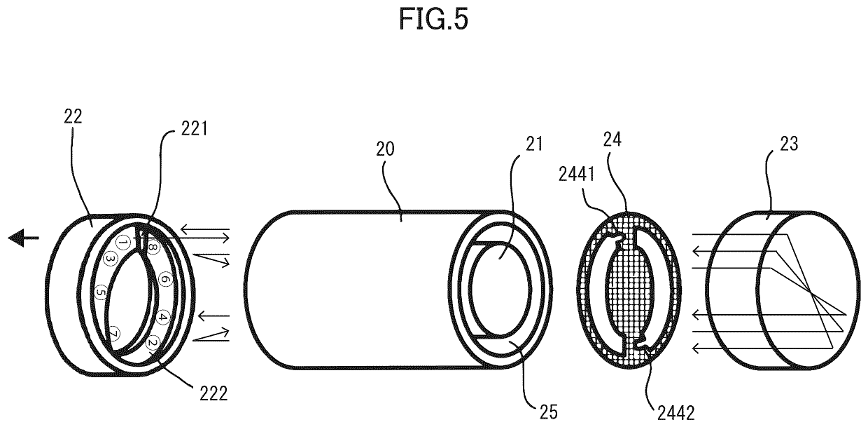

Further, an opening portion 244 through which the laser light L passes is formed between the outer support circle 241 and the inner support circle 242 concentrically arranged. FIG. 5 is a view illustrating a path through which the laser light L emitted from the discharge chamber 25 is reflected between the resonator mirrors 22 and 23 and is emitted from the output window 221. In addition, in FIG. 5, numbers 1 to 8 are given for convenience while a phase is changed in the circumferential direction so that the path of the laser light L can be understood.

As illustrated in FIG. 5, the laser light Lis emitted from the position of Phase Number 1, enters the second resonator mirror 23 through a first filter portion 2441 corresponding to Phase Number 1 in the opening portion 244 of the bracket 24, and is reflected toward the first resonator mirror 22 while the phase is changed by the second resonator mirror 23. Next, the laser light L folded back by the second resonator mirror 23 is incident on the first resonator mirror 22 through a second filter portion 2442 and the discharge chamber 25 corresponding to Phase Number 2 of the opening portion 244, and is reflected toward the second resonator mirror 23 while the phase is changed.

The laser light L that has been reflected a plurality of times by the resonator mirrors 22 and 23 and passed through the discharge chamber 25 and the first and second filter portions 2441 and 2442 a plurality of times passes through a laser passage window portion 2443 (in this case, a portion corresponding to Phase Number 3) that is a portion of the opening portion 244 other than the discharge chamber 25 and the first and second filter portions 2441 and 2442, and travels toward the first resonator mirror 22. As indicated by arrows in FIG. 5, the laser light L is reflected a plurality of times by portions corresponding to Phase Numbers 4 to 7 between the resonator mirrors 23 and 22, and is emitted to the outside from the output window 221 at the position of Phase Number 8.

Here, the first and second filter portions 2441 and 2442 of the opening portion 244 are space filters that are formed to have an opening width smaller than the beam diameter of the laser light emitted from the discharge chamber 25 and function as space filter portions. Hereinafter, the first and second filter portions 2441 and 2442 serving as the space filter portions will be described in detail.

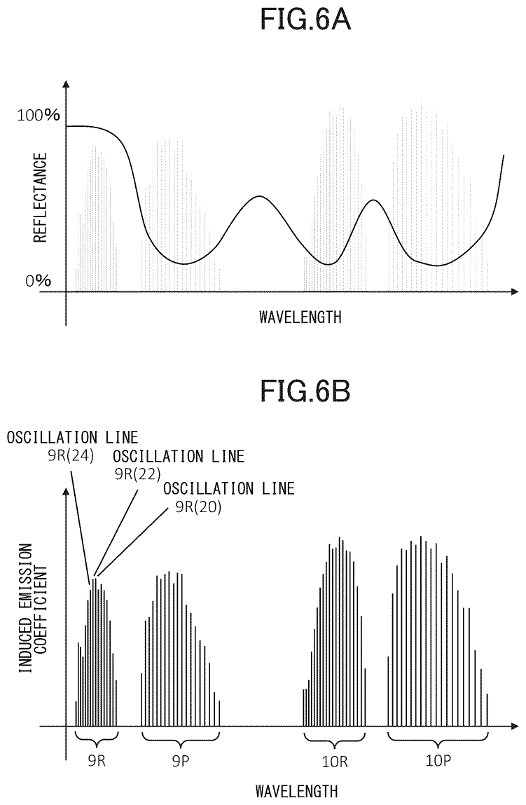

The first resonator mirror 22 described above is a band selection mirror (wavelength selection element) that selectively reflects laser light with a specific wavelength band (frequency band). FIG. 6A is a view illustrating a relationship between reflectance of the first resonator mirror 22 and a wavelength of laser light. FIG. 6B is a view illustrating a relationship between the wavelength and an oscillation line of the laser light L emitted from the discharge chamber 25. As can be seen from FIGS. 6A and 6B, in the first resonator mirror 22, reflectance of the laser light in a wavelength band of 9R that is a short wavelength band is high, and reflectance of the laser light in wavelength bands of 9P, 10R, and 10P that are longer than the wavelength band of 9R is low. Therefore, the wavelength of the laser light L emitted from the output window 221 is a wavelength of light in a short wavelength band of 9R.

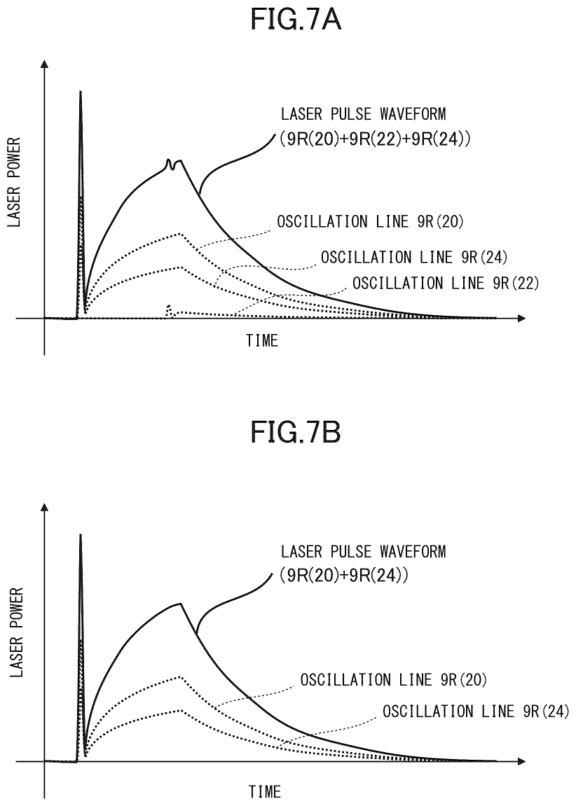

Meanwhile, even when oscillation of 9P, 10R, and 10P is inhibited by the first resonator mirror 22, noise may be generated in the laser light L as illustrated in FIG. 7A. Specifically, in the example of FIG. 7A, the oscillation line 9R (22) oscillating from the middle of the pulse becomes noise. That is, the oscillation line 9R (20) and the oscillation line 9R (24) oscillate from the beginning of one pulse, but the oscillation line 9R (22) oscillates from the middle of one pulse. An output laser pulse waveform has a form in which the oscillation line 9R (20), the oscillation line 9R (22), and the oscillation line 9R (24) are superimposed. Therefore, when noise of the oscillation line 9R (22) is generated, the pulse waveform is deformed with the noise riding on the laser pulse waveform, and the quality of the laser pulse may deteriorate.

Here, a beam diameter of the laser light L varies depending on a wavelength. The longer the wavelength of the oscillation line is, the larger the beam diameter is. Therefore, in the embodiment, it is configured that widths of the first and second filter portions 2441 and 2442 described above are formed to be narrower than the beam diameter of the laser light L before the laser light L passes through these filter portions such that the laser light L that has a long wavelength effectively attenuates. Specifically, in the embodiment, the widths of the first and second filter portions 2441 and 2442 are determined such that the laser light L with a wavelength of 9R (22) or more effectively attenuates.

That is, the first resonator mirror 22 is a band selection mirror that has high reflectance of the laser light of the specific wavelength band 9R, the specific wavelength band 9R includes the first wavelength 9R (24) and the second wavelength 9R (22) that has a longer wavelength than the first wavelength 9R (24), and opening widths of the space filter portions 2441 and 2442 are set such that the laser light L with the second wavelength 9R (22) or more effectively attenuates.

Also, as illustrated in FIGS. 4 and 5, the opening portion 244 of the bracket 24 is formed by two arc-shaped openings of which circumferences are divided by two connection portions 243, and each of the space filter portions 2441 and 2442 is formed at a first end of each arc-shaped opening portion 244. As described above, these first ends are phase positions at which the laser light L emitted from the discharge chamber 25 passes first and second in the opening portion 244 of the arc-shaped bracket 24, and the laser light L with a long wavelength effectively attenuates as soon as the laser light Lis emitted. Further, in the embodiment, the opening width of the laser passage window portion 2443 is formed to be larger than the opening width of the space filter portions 2441 and 2442 and the beam diameter of the laser light so that the laser light more than necessary does not attenuate for the space filter portions 2441 and 2442 and the subsequent portions.

When energy still remains in the oscillator despite consumption of energy for laser oscillation of the laser light L with the wavelength 9R (22) or 9R (20), the laser light L with the second wavelength 9R (24) oscillates using the energy. When there are the space filter portions 2441 and 2442, a loss exceeds a gain. Therefore, the laser light L with the second wavelength 9R (22) hardly oscillates. In particular, in the case of the embodiment, since the space filter portions 2441 and 2442 are provided at laser start positions as described above, the induced emission of the laser light L with the second wavelength 9R (22) is effectively inhibited, and the laser light L hardly oscillates.

In this case, the laser light L of the oscillation line 9R (20) also attenuates. However, since the laser light L of the oscillation line 9R (20) has a high gain, there is no problem in the output pulse waveform.

### SUMMARY

### Configuration 1

A laser oscillator (1) including:
a cylindrical outer electrode (20);
an inner electrode (21) disposed concentrically with the outer electrode (20) and forming a discharge chamber (25) filled with a laser medium between the inner electrode (21) and the outer electrode (20);
a first resonator mirror (22) provided on a first end side of the outer electrode (20) and the inner electrode (21) and configured to reflect laser light emitted from the discharge chamber (25); and
a second resonator mirror (23) provided on a second end side of the outer electrode (20) and the inner electrode (21) and configured to reflect the laser light between the second resonator mirror (23) and the first resonator mirror (22); and
a support member (24) configured to support the inner electrode (21),
wherein the support member (24) has an opening portion (244) through which the laser light passes at a position corresponding to the discharge chamber (25), and at least a part of the opening portion (244) has an opening width smaller than a beam diameter of the laser light emitted from the discharge chamber (25) and serves as a space filter portion (2441, 2442).

In this way, by causing at least a part of the opening portion 244 to be smaller than the beam diameter of the laser light emitted from the discharge chamber 25 before the laser light passes through the space filter portions 2441 and 2442, it is possible to effectively attenuate a long-wavelength component contained in the laser light. Accordingly, light with a wavelength that becomes noise effectively attenuates, and thus it is possible to output high quality laser light with a laser pulse waveform with less deformation. By using the laser light, for example, in a laser processing device, it is possible to drill a hole with a small variation in the diameter of the processed hole and high quality in a workpiece such as a printed circuit board.

### Configuration 2

The laser oscillator (1) according to Configuration 1, wherein the first resonator mirror (22) is a band selection mirror that has high reflectance of laser light in a specific wavelength band (9R), and wherein the specific wavelength band (9R) includes a first wavelength (9R (24)) and a second wavelength (9R (22) longer than the first wavelength (9R (24)), and
wherein an opening width of the space filter portion (2441, 2442) is set to effectively attenuate the laser light with the second wavelength or more.

With this configuration, it is possible to effectively attenuate the laser light with the wavelength that becomes noise by the space filter portions 2441 and 2442.

### Configuration 3

The laser oscillator (1) according to Configuration 1 or 2, wherein the opening portion (244) has a part (2443) that has an opening width larger (wider) than the space filter portion (2441, 2442) and through which laser light reflected between the first and second resonator mirrors passes.

In this way, since the space filter is not formed over the entire opening portion, it is not necessary to attenuate the laser light more than necessary.

### Configuration 4

The laser oscillator (1) according to any one of Configurations 1 to 3, wherein the support member (24) includes an outer diameter side support circular portion (241) attached to the outer electrode (20) and an inner diameter side support circular portion (242) to which the inner electrode (21) is attached, wherein the opening portion (244) is formed in an arc shape when viewed in an axial direction between the outer diameter side support circular portion (241) and the inner diameter side support circular portion (242), and wherein the space filter portion (2441, 2442) is formed at a first end of the arc-shaped opening portion (244).

With this configuration, it is possible to effectively attenuate the long-wavelength component of the laser light by the space filter at an initial stage in the reflection path of the laser light.

In the embodiment described above, the space filter portions 2441 and 2442 are formed on the second resonator mirror 23 side of the electrodes 20 and 21, but the present invention is not limited thereto. For example, the space filter portion may be formed on a support unit (for example, the spacer 26 or the like) on the first resonator mirror 22 side of the electrodes 20 and 21. The inventions described in the embodiment described above may be combined in any way.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-168681, filed Sep. 28, 2023, which is hereby incorporated by reference herein in its entirety.

What is claimed is:

1. A laser oscillator comprising:
a cylindrical outer electrode;
an inner electrode disposed concentrically with the outer electrode and forming a discharge chamber filled with a laser medium between the inner electrode and the outer electrode;
a first resonator mirror provided on a first end side of the outer electrode and the inner electrode and configured to reflect laser light emitted from the discharge chamber,
a second resonator mirror provided on a second end side of the outer electrode and the inner electrode and configured to reflect the laser light between the second resonator mirror and the first resonator mirror, and
a support member configured to support the inner electrode,
wherein the support member has an opening portion through which the laser light passes at a position corresponding to the discharge chamber, and at least a part of the opening portion has an opening width smaller than a beam diameter of the laser light emitted from the discharge chamber and serves as a space filter portion.

2. The laser oscillator according to claim 1,
wherein the first resonator mirror is a band selection mirror that has high reflectance of laser light in a specific wavelength band,
wherein the specific wavelength band includes a first wavelength and a second wavelength longer than the first wavelength, and
wherein the opening width of the space filter portion is set to attenuate laser light with the second wavelength or more.

3. The laser oscillator according to claim 1,
wherein the opening portion has a part that has an opening width larger than the space filter portion and through which laser light reflected between the first and second resonator mirrors passes.

4. The laser oscillator according to claim 3,
wherein the support member includes an outer diameter side support circular portion attached to the outer electrode and an inner diameter side support circular portion to which the inner electrode is attached,
wherein the opening portion is formed in an arc shape when viewed in an axial direction between the outer diameter side support circular portion and the inner diameter side support circular portion, and
wherein the space filter portion is formed at a first end of the arc-shaped opening portion.
